(19) United States
(12) Patent Application Publication
(10) Pub. No.: US 2026/0071999 A1
(43) Pub. Date: Mar. 12, 2026

(54) ULTRASOUND IMAGE PROCESSING APPARATUS

(71) Applicant: FUJIFILM Corporation, Tokyo (JP)

(72) Inventors: Yu ZHAO, Tokyo (JP); Takanori HIRAI, Tokyo (JP)

(73) Assignee: FUJIFILM Corporation, Tokyo (JP)

(21) Appl. No.: 19/305,299

(22) Filed: Aug. 20, 2025

(30) Foreign Application Priority Data
Sep. 10, 2024 (JP) 2024-156538

(51) Int. Cl. G01N 29/26; G01N 29/06

(52) U.S. Cl. CPC G01N 29/262; G01N 29/0645

(57) ABSTRACT

A guide image generation unit generates guide image data based on position and orientation information of an ultrasound probe. A guide image indicated by the guide image data indicates the position and the orientation of the ultrasound probe 12 with a figure. The guide image generation unit outputs the guide image data to an image combining unit. The image combining unit generates guide B-mode image data in which both a B-mode image and the guide image are shown, and outputs the guide B-mode image data to a display processing unit. The display processing unit 26 converts the guide B-mode image data output from the image combining unit 24 into a video signal and outputs the video signal to the display 46. The display displays a guide B-mode image based on the video signal.

### CROSS REFERENCE TO RELATED APPLICATION

This application claims priority to Japanese Patent Application No. 2024-156538 filed on Sep. 10, 2024 which is incorporated herein by reference in its entirety including the specification, claims, drawings, and abstract.

### BACKGROUND OF THE INVENTION

### 1. Field of the Invention

The present disclosure relates to an ultrasound image processing apparatus, and particularly to an apparatus that generates ultrasound image data based on ultrasound waves transmitted and received by an ultrasound probe.

### 2. Description of the Related Art

There is a technique of sequentially acquiring B-mode image data while manually transporting an ultrasound probe, and acquiring volume data composed of the B-mode image data of a plurality of frames. JP2018-20109A discloses acquiring volume data using an ultrasound diagnostic apparatus. It is disclosed that the ultrasound probe is provided with a position sensor, and that an indicator indicating a speed of the ultrasound probe calculated based on an output of the position sensor and a recommended range of the speed of the ultrasound probe is displayed. In addition, JP2018-20109A discloses displaying, for volume data, an indicator indicating information about uniformity of data collection density.

### SUMMARY OF THE INVENTION

In a case of manually transporting the ultrasound probe, it may be difficult for a user to ascertain whether or not the ultrasound probe is being properly transported.

In addition, the quality of the volume data acquired by the manual transport of the ultrasound probe varies depending on a state of the manual transport. In addition, image processing on the volume data takes a long time. Therefore, it is desirable for the user to ascertain whether the quality of the volume data is good or bad before executing the image processing.

An object of the present disclosure is to facilitate determination of whether an ultrasound probe is being properly transported or determination of whether the ultrasound probe has been properly transported in an apparatus that acquires volume data by transporting the ultrasound probe.

An ultrasound image processing apparatus according to the present disclosure comprises: a position and orientation sensor provided in an ultrasound probe; and a processor, in which the processor executes processing of sequentially generating ultrasound image data over time based on ultrasound waves transmitted and received by the ultrasound probe, processing of sequentially generating position and orientation information indicating a position and an orientation of the ultrasound probe over time based on detection signals output sequentially over time by the position and orientation sensor, and processing of sequentially displaying, on a display unit, position and orientation figures indicating the position and the orientation of the ultrasound probe over time based on the position and orientation information generated sequentially over time.

In one embodiment, the position and orientation figure has a shape extending in a certain direction, the direction in which the position and orientation figure extends indicates the orientation of the ultrasound probe, and a position of the position and orientation figure indicates the position of the ultrasound probe.

In one embodiment, the processor executes processing of obtaining future position and orientation information by performing estimation processing on the position and orientation information generated over time, and processing of displaying an estimated range based on the future position and orientation information on the display unit.

An ultrasound image processing apparatus according to the present disclosure comprises: a position and orientation sensor provided in an ultrasound probe; and a processor, in which the processor executes processing of sequentially generating ultrasound image data over time based on ultrasound waves transmitted and received by the ultrasound probe, processing of obtaining a scan rate indicating the number of frames of the ultrasound image data acquired per predetermined amount of movement of the ultrasound probe based on a detection signal output by the position and orientation sensor, and processing of displaying evaluation information for the scan rate on a display unit.

In one embodiment, the position and orientation sensor receives a positioning signal transmitted from a positioning signal generation source, and outputs the detection signal based on the positioning signal, and the processor causes the display unit to display information indicating strength of the positioning signal received by the position and orientation sensor.

An ultrasound image processing apparatus according to the present disclosure comprises: a position and orientation sensor fixed to an ultrasound probe; and a processor, in which the processor executes processing of sequentially generating ultrasound image data over time based on ultrasound waves transmitted and received by the ultrasound probe, processing of generating transport information indicating a transport status of the ultrasound probe for volume data composed of the ultrasound image data of a predetermined number of frames, based on a detection signal output by the position and orientation sensor, and processing of determining quality of the volume data based on the transport information.

According to the present disclosure, it is possible to facilitate determination of whether the ultrasound probe is being properly transported or determination of whether the ultrasound probe has been properly transported.

### BRIEF DESCRIPTION OF THE DRAWINGS

FIG. 1 is a diagram showing a configuration of an ultrasound diagnostic apparatus according to an embodiment of the present disclosure.

FIG. 2 is a diagram showing a state in which an observation surface is swung with a minor axis direction as a circumferential direction.

FIG. 3 is a diagram showing an example of a guide B-mode image.

FIG. 4 is a diagram showing an example of a guide B-mode image.

FIG. 5 conceptually shows a linear scan of an ultrasound probe.

FIG. 6 is a diagram showing an example of a guide B-mode image.

FIG. 7 is a flowchart of scan speed determination in a case of performing a swing scan.

FIG. 8 is a diagram showing an example of a guide B-mode image in which a result of the scan speed determination is shown.

FIG. 9 is a diagram showing an example of a guide B-mode image in which a result of the scan speed determination is shown.

FIG. 10 is a flowchart of scan speed determination in a case of performing a linear scan.

FIG. 11 is a diagram showing an example of a guide B-mode image in which a result of the scan speed determination is shown.

FIG. 12 is a diagram showing an example of an image displayed on a display in a case where a scan time exceeds a limit time.

FIG. 13 is a diagram showing an example of an image displayed on the display in a case where a major axis deviation is recognized.

### DESCRIPTION OF THE PREFERRED EMBODIMENTS

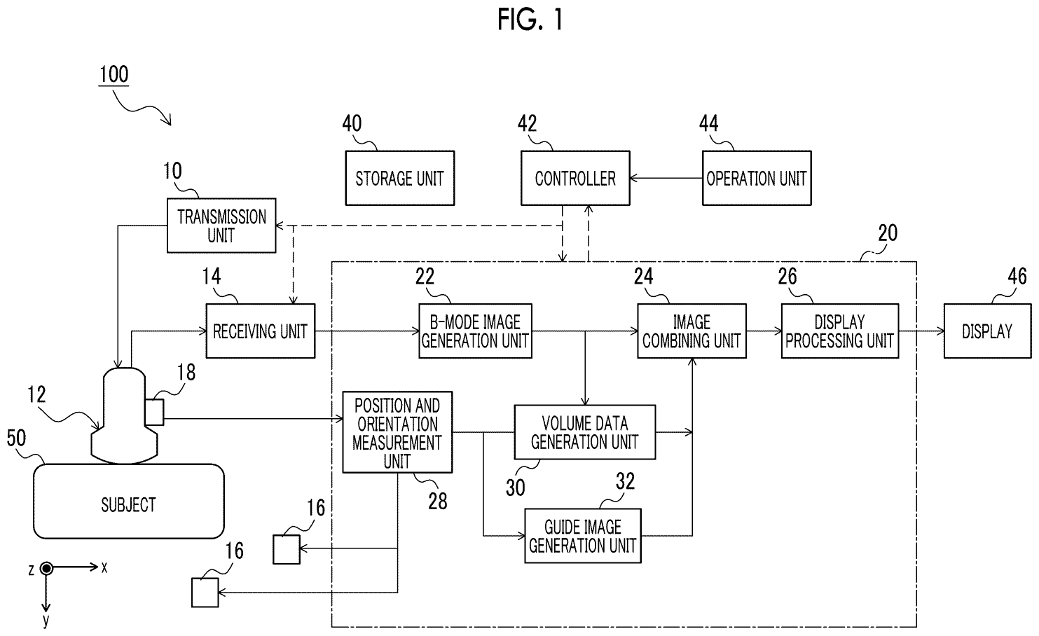

An embodiment of the present disclosure will be described with reference to the drawings. The same components shown in a plurality of drawings are denoted by the same reference numerals to simplify the description thereof. FIG. 1 shows a configuration of an ultrasound diagnostic apparatus 100 according to an embodiment of the present disclosure.

The ultrasound diagnostic apparatus 100 comprises a transmission unit 10, an ultrasound probe 12, a receiving unit 14, an information processing unit 20, a controller 42, an operation unit 44, a display 46, a plurality of positioning signal generation sources 16, and a position and orientation sensor 18.

The operation unit 44 may comprise a button, a lever, a keyboard, a mouse, and the like. The operation unit 44 may be a touch panel provided on the display 46. A storage unit 40 shown in FIG. 1 together with the ultrasound diagnostic apparatus 100 may be a storage device such as a hard disk mounted in the ultrasound diagnostic apparatus 100. In addition, the storage unit 40 may be a memory of a computer on a local area network or a memory of a computer on an electric communication line such as the Internet.

The information processing unit 20 comprises a B-mode image generation unit 22, an image combining unit 24, a display processing unit 26, a position and orientation measurement unit 28, a volume data generation unit 30, and a guide image generation unit 32.

The information processing unit 20 and the controller 42 may be configured by, for example, one or a plurality of processors that execute a program stored in the storage unit 40. The processor may be configured by a computer comprising an integrated circuit and peripheral components thereof.

The information processing unit 20 executes a program to configure each component (the B-mode image generation unit 22, the image combining unit 24, the display processing unit 26, the position and orientation measurement unit 28, the volume data generation unit 30, and the guide image generation unit 32) and to operate as an ultrasound image processing apparatus. The controller 42 may acquire information generated by each component in the information processing unit 20. In addition, the controller 42 may control the transmission unit 10, the receiving unit 14, and the information processing unit 20 in response to a user's operation of the operation unit 44.

The position and orientation measurement unit 28 outputs a positioning signal to each of the plurality of positioning signal generation sources 16 and causes the plurality of positioning signal generation sources 16 to transmit the positioning signals. The positioning signal transmitted from the positioning signal generation source 16 may be any of a radio wave, an ultrasound wave, or a magnetic field. The position and orientation sensor 18 is provided in the ultrasound probe 12. The position and orientation sensor 18 receives the positioning signal, generates a detection signal for measuring the position and the orientation (hereinafter, referred to as position and orientation) of the ultrasound probe 12, and outputs the detection signal to the position and orientation measurement unit 28. The position of the ultrasound probe 12 is a position of a reference point defined on the ultrasound probe 12. The orientation of the ultrasound probe 12 may be defined by an angle of a reference straight line defined on the ultrasound probe 12 relative to an xy plane, an angle between the reference straight line and a z-axis, and the like. The reference straight line may be defined, for example, as a straight line perpendicular to both a major axis direction and a minor axis direction of a surface of the ultrasound probe 12 that comes into contact with a subject 50. The position and orientation measurement unit 28 generates information indicating the position and orientation of the ultrasound probe 12 based on the detection signal output from the position and orientation sensor 18 and the positioning signal output to each positioning signal generation source 16, and outputs the information to the volume data generation unit 30 and the guide image generation unit 32.

The ultrasound probe 12 comprises a plurality of ultrasound transducers arranged on a contact surface facing a positive y-axis direction side. The transmission unit 10 performs the following operation under the control of the controller 42. The transmission unit 10 outputs a transmission signal to each ultrasound transducer, and each ultrasound transducer generates an ultrasound wave in response to the transmission signal output from the transmission unit 10 to itself. The transmission unit 10 adjusts a delay time of the transmission signal output to each ultrasound transducer such that the ultrasound waves emitted from the respective ultrasound transducers constructively interfere in a specific transmission beam direction. As a result, a transmission beam is formed in the transmission beam direction. The transmission unit 10 further adjusts the delay time of the transmission signal output to each ultrasound transducer after the transmission beam is formed, and scans an observation surface of the subject 50 with the transmission beam.

The respective ultrasound transducers receive reflected ultrasound waves generated by being reflected within the subject 50, convert the reflected ultrasound waves into a reception signal, which is an electric signal, and output the reception signal to the receiving unit 14. The receiving unit 14 performs the following operation under the control of the controller 42.

The receiving unit 14 adjusts the delay time of each reception signal output from each ultrasound transducer and performs synthesis processing, such as phasing addition, such that a plurality of reception signals based on ultrasound waves arriving from a direction in which the transmission beam is directed constructively interfere each other, thereby generating reception beam data. The reception beam data is data based on the ultrasound wave reflected in the direction in which the transmission beam is directed. As a result, directivity is created for the ultrasound wave arriving from the direction in which the transmission beam is directed, and a reception beam is formed in the direction in which the transmission beam is directed. In the following description, the transmission beam and the reception beam are collectively referred to as transmission and reception beams.

The receiving unit 14 generates reception beam data corresponding to each direction of the transmission and reception beams scanned over the subject 50, and outputs the reception beam data to the B-mode image generation unit 22. The B-mode image generation unit 22 repeatedly scans the observation surface of the subject 50 with the transmission and reception beams over time, and sequentially generates B-mode image data as the ultrasound image data over time. The B-mode image generation unit 22 sequentially outputs the B-mode image data to the image combining unit 24 and the volume data generation unit 30 over time.

The operation modes of the ultrasound diagnostic apparatus 100 according to the present embodiment include a B-mode image display mode and a volume data acquisition mode. The B-mode image display mode is an operation mode in which the B-mode image is displayed on the display 46 as a display unit in real time. That is, the B-mode image display mode is an operation mode in which the B-mode images are sequentially displayed on the display 46 over time based on the B-mode image data generated over time.

The volume data acquisition mode is a mode in which the user manually transports the ultrasound probe 12, that is, performs scanning, sequentially generates the B-mode image data over time, and acquires the volume data. A series of B-mode image data acquired over a time during which a scan is performed with the ultrasound probe 12 constitutes the volume data.

The B-mode image display mode will be described. The image combining unit 24 performs image quality adjustment processing, such as brightness adjustment, contrast adjustment, and contour highlighting, on the B-mode image data generated sequentially over time, and outputs the B-mode image data after the image quality adjustment processing to the display processing unit 26. The display processing unit 26 sequentially converts the B-mode image data output from the image combining unit 24 into a video signal over time, and outputs the video signal to the display 46. The display 46 displays a real-time B-mode image based on the video signal.

Next, the volume data acquisition mode will be described. In the volume data acquisition mode, in a case where the ultrasound diagnostic apparatus 100 is operating in the B mode, the user manually swings the ultrasound probe 12 in the minor axis direction as a circumferential direction to swing the observation surface. The swing scan is performed over a scan time from an operation of the user to start the scan (volume data acquisition start) to an operation of the user to end the scan (volume data acquisition end) with respect to the operation unit 44.

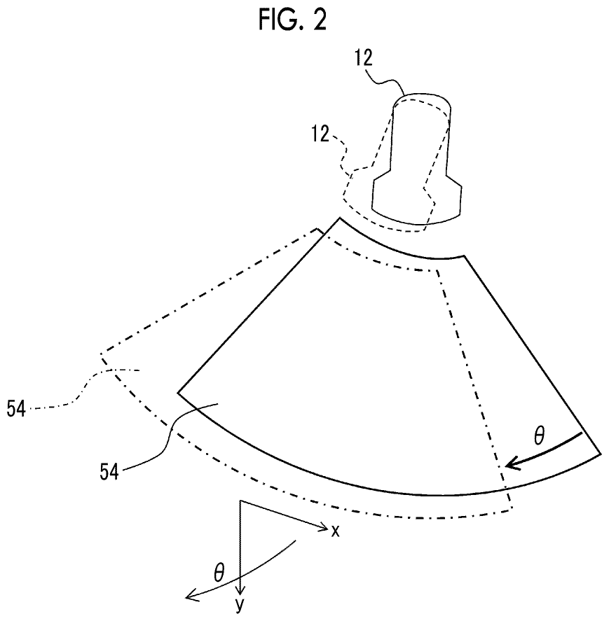

FIG. 2 shows a state in which an observation surface 54 is swung with the major axis direction of the ultrasound probe 12 as an x-axis direction, a direction from the ultrasound probe 12 toward the subject 50 as a positive y-axis direction, and the minor axis direction as a circumferential direction. A swing angle θ shown in FIG. 2 is an angle of the observation surface 54 relative to the xy plane.

The position and orientation measurement unit 28 measures the position and the orientation of the ultrasound probe 12 based on the positioning signals output to the plurality of positioning signal generation sources 16 and the detection signal output from the position and orientation sensor 18. The position and orientation measurement unit 28 outputs position and orientation information indicating the position and the orientation of the ultrasound probe 12 to the volume data generation unit 30 and the guide image generation unit 32.

The volume data generation unit 30 may associate data indicating the position and orientation information with each piece of the B-mode image data output sequentially over time from the B-mode image generation unit 22, and add the data to each piece of the B-mode image data. The volume data generation unit 30 stores the series of B-mode image data output from the B-mode image generation unit 22 during the scan time as the volume data. The volume data generation unit 30 may store the volume data in the storage unit 40.

The guide image generation unit 32 generates guide image data based on the position and orientation information of the ultrasound probe 12. A guide image indicated by the guide image data indicates the position and the orientation of the ultrasound probe 12 with a figure. The guide image generation unit 32 sequentially generates the guide image data over time, and outputs the guide image data generated sequentially over time to the image combining unit 24. The image combining unit 24 sequentially generates, over time, guide B-mode image data in which both the B-mode image and the guide image are shown, and outputs the guide B-mode image data to the display processing unit 26. The display processing unit 26 converts the guide B-mode image data output from the image combining unit 24 into a video signal and outputs the video signal to the display 46. The display 46 sequentially displays the guide B-mode images over time based on the video signal.

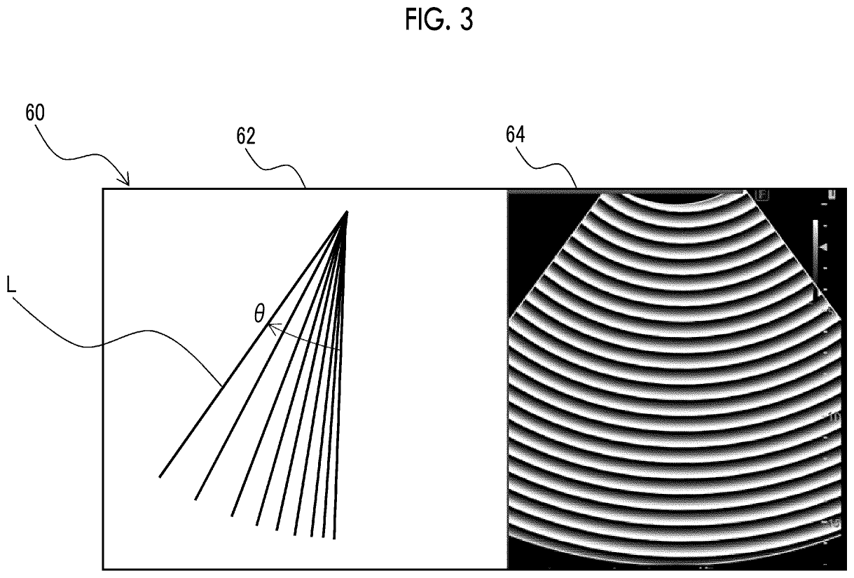

FIG. 3 shows an example of the guide B-mode image. A guide B-mode image 60 is an image in which a guide image 62 and a B-mode image 64 are arranged. The B-mode image 64 is shown on a right side, and the guide image 62 is shown on a left side. The guide image 62 is an image representing a locus line L as a position and orientation figure representing the position and orientation of the ultrasound probe 12. The locus line L is an imaginary straight line that passes through the center of the contact surface of the ultrasound probe 12 perpendicularly to the contact surface. In the real-time guide image 62, a plurality of locus lines L with sequentially increasing swing angles θ are sequentially added as time elapses after the operation to start the volume data acquisition is performed.

The position and orientation figure indicating the position and orientation of the ultrasound probe 12 may be a figure having a shape extending in a certain direction and is not limited to the locus line L. The direction in which the position and orientation figure extends indicates the orientation of the ultrasound probe 12, and a position of the position and orientation figure indicates the position of the ultrasound probe 12.

The guide image generation unit 32 may execute processing of estimating future position and orientation of the ultrasound probe 12 by performing estimation processing on the position and orientation information output sequentially over time from the position and orientation measurement unit 28. The guide image generation unit 32 may perform, for example, estimation processing, such as Kalman filter processing, on the position and orientation information output from the position and orientation measurement unit 28 over a predetermined time in the past, and estimate the position and orientation information at time point t0+jδ, with t0 being a time point at which the position and orientation information was last output from the position and orientation measurement unit 28. Here, j is an integer of 1 or more. In addition, δ is a predetermined time interval.

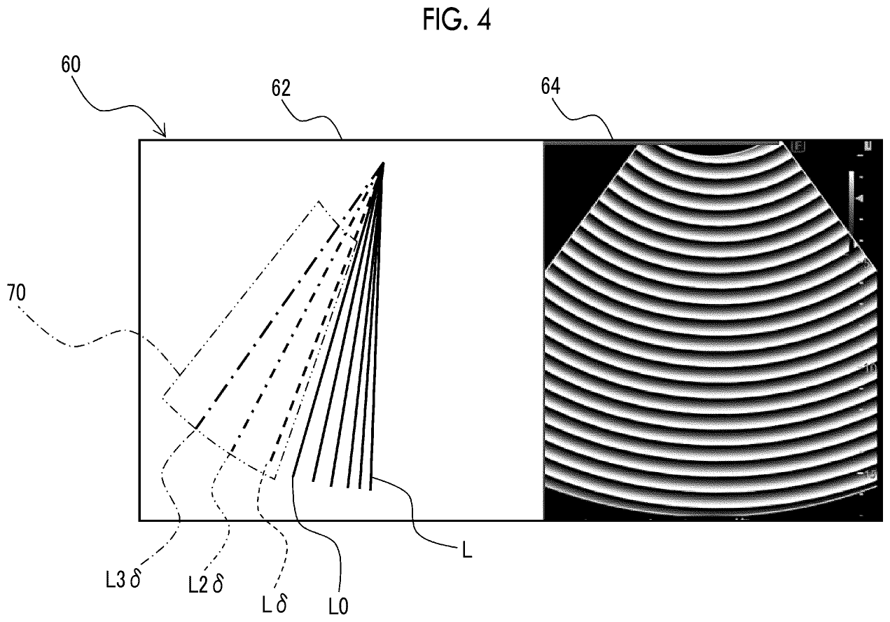

The guide image 62 shown in FIG. 4 shows a locus line L0 based on the position and orientation information last output at time point t0 from the position and orientation measurement unit 28 and locus lines Lδ to L3δ based on the position and orientation information estimated as the position and orientation information at time point t0+δ to time point t0+3δ. In addition, the guide image generation unit 32 may generate guide image data in which a figure shows an estimated range spanned by a locus line at time point t0+jδ in the future in the guide image 62. The guide image 62 shown in FIG. 4 shows an estimated range FIG. 70 showing an estimated range spanned by the locus line L.

In the above description, the swing scan has been described in which the user manually swings the ultrasound probe 12 to swing the observation surface 54 in the volume data acquisition mode. In the volume data acquisition mode, a linear scan in which the ultrasound probe 12 is linearly transported in the minor axis direction (z-axis direction) may be performed.

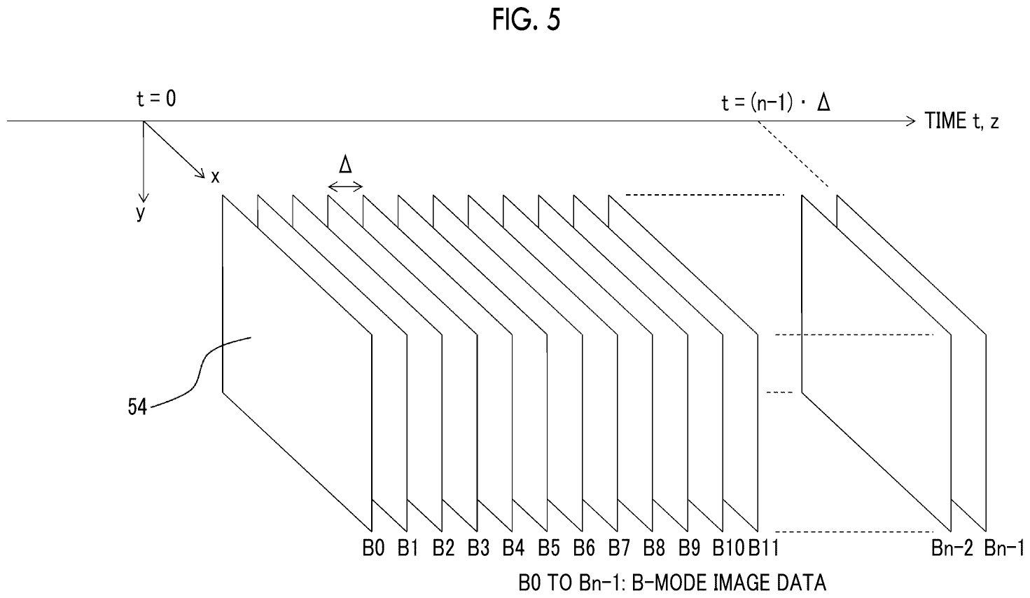

FIG. 5 conceptually shows processing of acquiring the B-mode image data for each time interval Δ from time point t=0 to time point t=(n−1)·Δ in a case where a linear scan is performed with the ultrasound probe 12 in the minor axis direction while aligning the observation surface 54 in the direction along the xy plane. Each of rectangles B0 to Bn−1 arranged in parallel with the xy plane at the time interval Δ on a time axis corresponds to the B-mode image indicated by the B-mode image data.

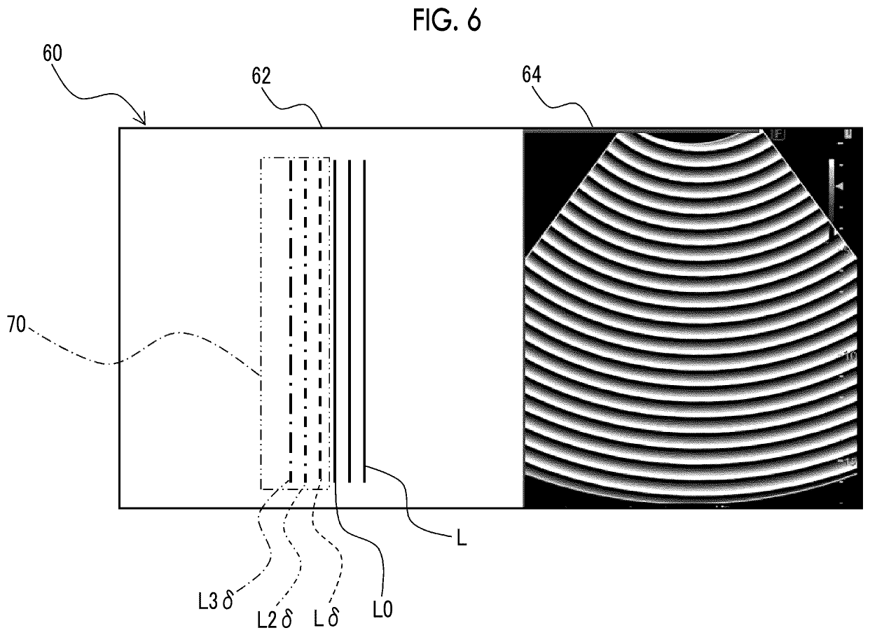

The guide image 62 shown in FIG. 6 shows a locus line L0 based on the position and orientation information last output at time point t0 from the position and orientation measurement unit 28 and locus lines Lδ to L3δ based on the position and orientation information estimated as the position and orientation information at time point t0+δ to time point t0+3δ. In addition, the guide image generation unit 32 may generate guide image data in which a figure shows an estimated range spanned by a locus line L at time point t0+jδ in the future in the guide image 62. The guide image 62 shown in FIG. 6 shows an estimated range FIG. 70 showing an estimated range spanned by the locus line L.

As described above, in the operation of the volume data acquisition mode, the guide B-mode image is displayed on the display 46. In the guide image 62 included in the guide B-mode image, the position and orientation of the ultrasound probe 12 subjected to the swing scan or the linear scan are indicated by the locus line L. As a result, the user checks whether a scan with the ultrasound probe 12 is performed at an appropriate position and an appropriate speed. In a case where the user recognizes that a scan with the ultrasound probe 12 is not performed at an appropriate position and an appropriate speed, the user corrects the position and the speed of the ultrasound probe 12. In addition, the user may reacquire the volume data.

In the volume data acquisition mode, the controller 42 may execute scan speed determination as to whether or not the scan speed of the ultrasound probe 12 is appropriate. In the scan speed determination, the user operates the operation unit 44 to designate whether to perform the swing scan or the linear scan.

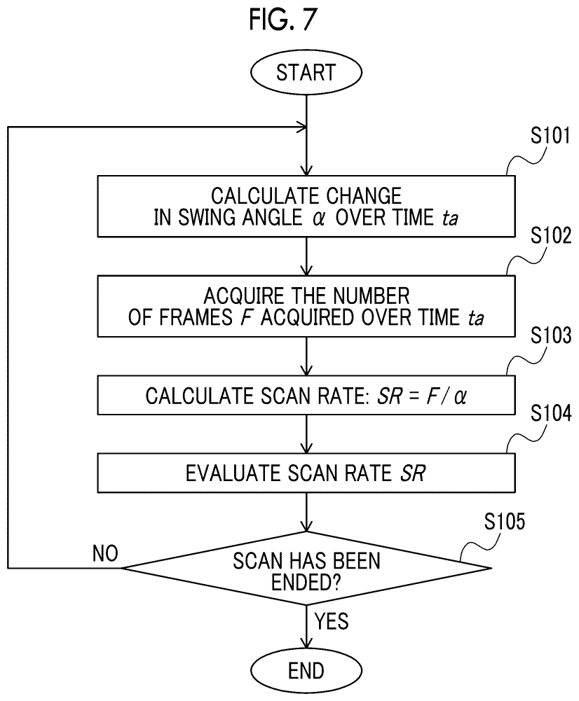

FIG. 7 shows a flowchart of scan speed determination in a case of performing the swing scan. The controller 42 refers to the position and orientation information obtained by the position and orientation measurement unit 28, and obtains a change angle α by which the swing angle has changed over a predetermined time ta prior to the current time (S101).

The controller 42 refers to the operation of the B-mode image generation unit 22 and acquires the number of frames F of the B-mode image data acquired over a predetermined time ta in the past (S102). The controller 42 obtains a scan rate SR obtained by dividing the number of frames F by the change angle α (S103), and evaluates the scan rate SR (S104). The scan rate SR indicates the number of frames of the B-mode image data (ultrasound image data) acquired per predetermined amount of movement of the ultrasound probe 12. In the present embodiment, the predetermined amount of movement is the swing angle (1°) of the ultrasound probe 12.

The controller 42 evaluates the scan rate SR as follows, for example. In a case where the scan rate SR is smaller than a predetermined first scan rate threshold value S1, the controller 42 determines that the swing scan is fast. In addition, in a case where the scan rate SR is greater than a predetermined second scan rate threshold value S2, the controller 42 determines that the swing scan is slow. Further, in a case where the scan rate SR is equal to or greater than the first scan rate threshold value S1 and is equal to or less than the second scan rate threshold value S2, the controller 42 determines that the swing scan is at a normal speed.

The controller 42 may control the guide image generation unit 32 such that the guide image generation unit 32 generates guide image data indicating evaluation information of the scan rate SR. The guide image generation unit 32 generates the guide image data such that the guide image 62 includes an indicator indicating any of a fast swing scan, a normal swing scan, or a slow swing scan, based on the control of the controller 42.

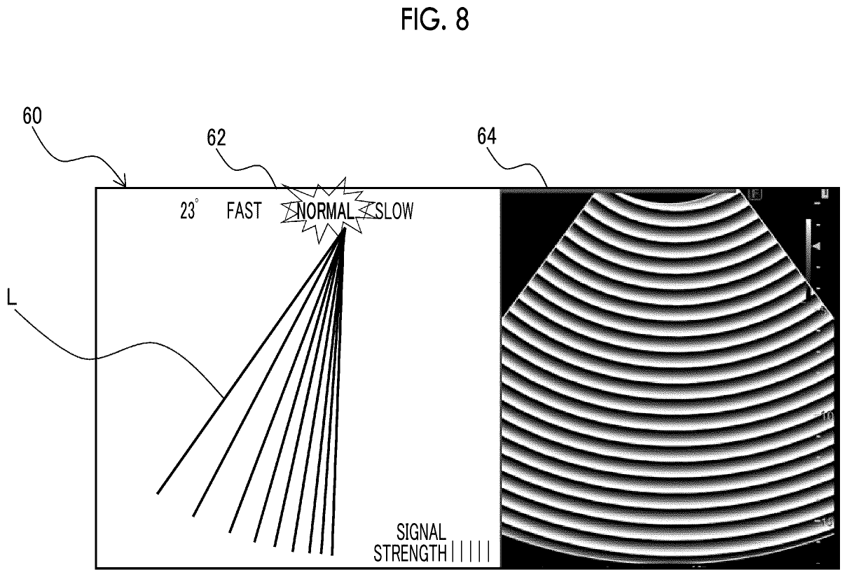

The guide image generation unit 32 may generate guide image data indicating the guide image 62 shown in FIG. 8. The guide image generation unit 32 may generate guide image data in which the corresponding one of the display of the text “fast” indicating that the swing scan is fast, the display of the text “normal” indicating that the swing scan is at a normal speed, and the display of the text “slow” indicating that the swing scan is slow is highlighted. In the guide image 62 shown in FIG. 8, the highlighting is performed by making the corresponding one brighter than the other text. The highlighting may be performed by changing the color or the font.

For the acquisition of the volume data, a slow swing scan may be more appropriate. In this case, the display of “fast”, “normal”, and “slow” may be replaced with the display of “too fast”, “appropriate”, and “more appropriate”, or the display of “too fast”, “good”, and “perfect”.

The controller 42 may cause the guide image generation unit 32 to generate guide image data showing the change angle α over time ta as shown in the guide image 62. In the guide image 62 of FIG. 8, the text “23°” is displayed as the change angle α.

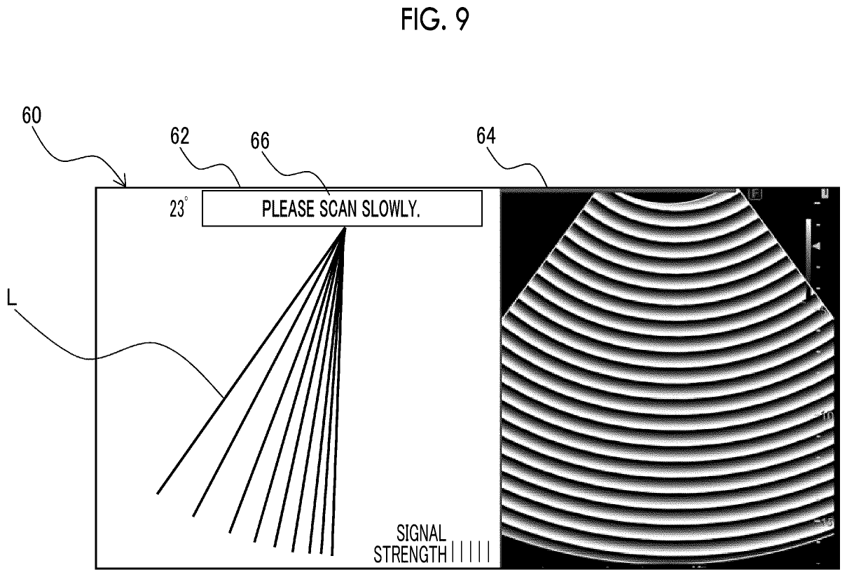

For the evaluation of the scan rate SR, as shown in FIG. 9, a scan rate evaluation display region 66 may be provided. In the scan rate evaluation display region 66, an instruction to the user may be displayed according to an evaluation result of the scan rate SR. For example, as shown in FIG. 9, in a case where the scan rate SR is smaller than the first scan rate threshold value S1, an instruction “please scan slowly” may be displayed. This instruction may be displayed in a foreign language. In addition, in a case where the scan rate SR is equal to or greater than the first scan rate threshold value S1, a message such as “scan speed is appropriate”may be displayed.

In the scan rate evaluation display region 66, the corresponding one of the above-mentioned text of “fast”, “normal”, and “slow” may be displayed. In addition, in the scan rate evaluation display region 66, a mark indicating that the swing scan is fast, that the swing scan is at a normal speed, or that the swing scan is slow may be displayed instead of the text. Further, a design may be made in which the instruction is not displayed in the scan rate evaluation display region 66 in a case where the swing scan is slow and the swing scan is at an appropriate speed, and the instruction is displayed in the scan rate evaluation display region 66 in a case where the swing scan is fast. That is, a design may be made in which the instruction is not displayed in the scan rate evaluation display region 66 in a case where the scan rate SR is equal to or greater than the first scan rate threshold value S1, and the instruction such as “please scan slowly” is displayed in the scan rate evaluation display region 66 in a case where the scan rate SR is smaller than the first scan rate threshold value S1.

The controller 42 determines whether or not the operation to end the scan has been performed on the operation unit 44 (S105). In a case where it is determined that the operation to end the scan has not been performed, the controller 42 returns to step S101, and, in a case where it is determined that the operation to end the scan has been performed, the controller 42 ends the scan speed determination.

The guide image generation unit 32 may reflect a result of the latest scan speed determination obtained at the time of generating the guide image data on each guide image data sequentially generated over time from the operation to start the scan to the operation to end the scan. As a result, real-time indication of whether or not the speed of the swing scan is appropriate is provided.

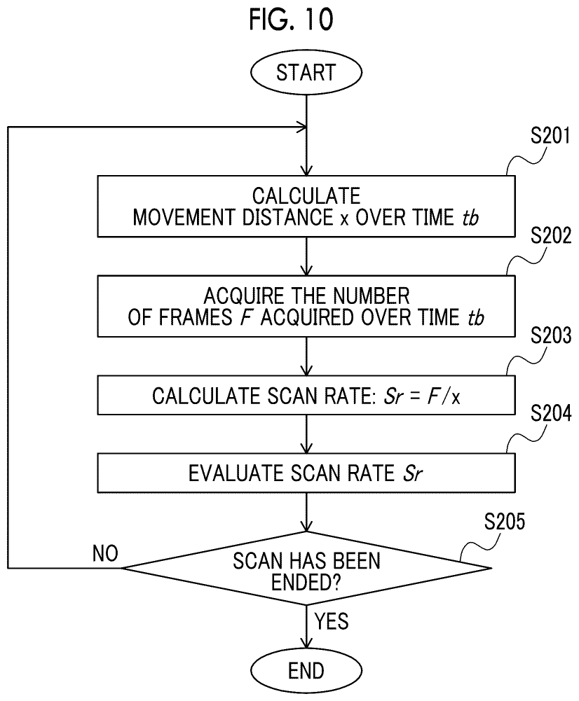

FIG. 10 shows a flowchart of scan speed determination in a case of performing the linear scan. The controller 42 refers to the position and orientation information obtained by the position and orientation measurement unit 28, and obtains a movement distance x that is a distance by which the ultrasound probe 12 has moved over a predetermined time tb prior to the current time (S201).

The controller 42 refers to the operation of the B-mode image generation unit 22 and acquires the number of frames F of the B-mode image data acquired over a predetermined time tb in the past (S202). The controller 42 obtains a scan rate Sr obtained by dividing the number of frames F by the movement distance x (S203), and evaluates the scan rate Sr (S204). The scan rate Sr indicates the number of frames of the B-mode image data (ultrasound image data) acquired per predetermined amount of movement of the ultrasound probe 12. In the present embodiment, the predetermined amount of movement is a unit movement distance [cm] of the ultrasound probe 12.

The controller 42 evaluates the scan rate Sr as follows. In a case where the scan rate Sr is smaller than a predetermined third scan rate threshold value S3, the controller 42 determines that the linear scan is fast. In addition, in a case where the scan rate Sr is greater than a predetermined fourth scan rate threshold value S4, the controller 42 determines that the linear scan is slow. Further, in a case where the scan rate Sr is equal to or greater than the third scan rate threshold value S3 and is equal to or less than the fourth scan rate threshold value S4, the controller 42 determines that the linear scan is at a normal speed.

As in a case where the swing scan is performed, the controller 42 may control the guide image generation unit 32 such that the guide image generation unit 32 generates guide image data indicating evaluation information of the scan rate Sr. The guide image generation unit 32 generates the guide image data such that the guide image 62 includes an indicator indicating any of a slow linear scan, a normal linear scan, or a fast linear scan, based on the control of the controller 42.

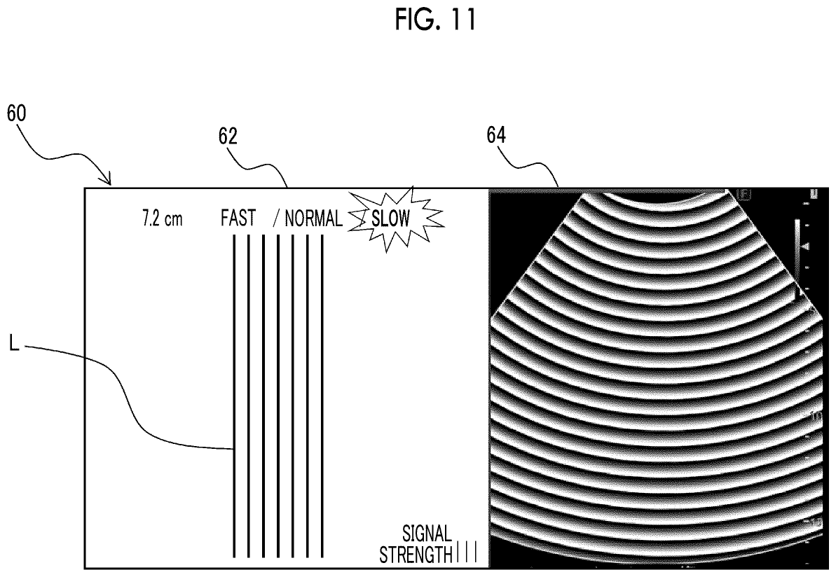

The guide image generation unit 32 may generate guide image data indicating the guide image 62 shown in FIG. 11. The guide image generation unit 32 may generate guide image data indicating a guide image in which the corresponding one of the display of the text “fast” indicating that the linear scan is fast, the display of the text “normal” indicating that the linear scan is at a normal speed, and the display of the text “slow” indicating that the linear scan is slow is highlighted. The display of “fast”, “normal”, and “slow” may be replaced with the display of “too fast”, “appropriate”, and “more appropriate”, or the display of “too fast”, “good”, and “perfect”. In the guide image 62 shown in FIG. 11, the highlighting is performed by making the corresponding one brighter than the other text. The highlighting may be performed by changing the color or the font.

The controller 42 may cause the guide image generation unit 32 to generate guide image data showing the movement distance x over time tb as shown in the guide image 62. In the guide image 62 of FIG. 11, the text “7.2 cm” is displayed as the movement distance x. Even in a case where the linear scan is performed, as shown in FIG. 9, the guide image 62 may include the scan rate evaluation display region 66. In this case, in the scan rate evaluation display region 66, evaluation, an instruction, and the like for the speed of the linear scan are displayed, as in the swing scan.

The controller 42 determines whether or not the operation to end the scan has been performed on the operation unit 44 (S205). In a case where it is determined that the operation to end the scan has not been performed, the controller 42 returns to step S201, and, in a case where it is determined that the operation to end the scan has been performed, the controller 42 ends the scan speed determination.

The guide image generation unit 32 may reflect a result of the latest scan speed determination obtained at the time of generating the guide image data on each guide image data sequentially generated over time from the operation to start the scan to the operation to end the scan. As a result, real-time indication of whether or not the speed of the linear scan is appropriate is provided.

The scan speed determination and the display of the result allow the user to check whether a scan with the ultrasound probe 12 is performed at an appropriate speed. In a case where the user recognizes that a scan with the ultrasound probe 12 is not performed at an appropriate speed, the user adjusts the speed of the ultrasound probe 12. In addition, the user may reacquire the volume data.

The controller 42 may cause the guide image generation unit 32 to generate guide image data indicating the strength of the positioning signal received by the position and orientation sensor 18. In this case, the position and orientation sensor 18 outputs strength information indicating the strength of the positioning signal to the position and orientation measurement unit 28, and the position and orientation measurement unit 28 outputs the strength information to the guide image generation unit 32. The guide image generation unit 32 generates guide image data indicating a numerical value, an indicator, or the like showing the strength of the positioning signal received by the position and orientation sensor 18. In the guide images of FIGS. 8, 9, and 11, an indicator indicating the strength of the positioning signal is shown as a “signal strength” (received signal strength indicator). Next to the display of the “signal strength”, the strength of the positioning signal is shown by the number of straight lines extending in a vertical direction.

As a result, the strength of the positioning signal received by the position and orientation sensor 18 is shown in the guide image 62 displayed on the display 46. In this case, the user may refer to the display 46 while performing the scan with the ultrasound probe 12. In a case where the user determines that the strength of the positioning signal is not sufficient, the user may stop the processing of acquiring the volume data. This makes it possible to avoid acquiring the volume data in a state where the position of the ultrasound probe 12 is unclear.

In the volume data acquisition mode, the controller 42 may execute processing of evaluating the quality of the volume data. In the volume data evaluation processing, the controller 42 generates transport information indicating a transport status of the ultrasound probe 12 for the volume data composed of the B-mode image data of a predetermined number of frames, based on the position and orientation information output sequentially over time by the position and orientation measurement unit 28. The controller 42 further determines the quality of the volume data based on the transport information. In the volume data evaluation processing, the user operates the operation unit 44 to designate whether the ultrasound probe 12 is to perform the swing scan or the linear scan.

In a case where the swing scan is performed, the transport information indicating the transport status of the ultrasound probe 12 includes a scan time, a major axis deviation, a total change angle during the scan time, a locus line density, and the like. Here, the scan time is a time from the operation to start the scan to the operation to end the scan. The major axis deviation may be defined as a statistical value such as an average value, a maximum value, or a median value of a swing angle β in the major axis direction within a scan time. The total change angle during the scan time is an angle by which the orientation of the ultrasound probe 12 has changed in the minor axis direction during the scan time. The locus line density may be defined as a value obtained by dividing the number of locus lines L drawn within the scan time by the total change angle during the scan time.

In a case where the swing scan is performed, for example, in a case where at least one of the following conditions (i) to (iv) is satisfied, the controller 42 determines that the quality of the volume data is unacceptable. On the other hand, in a case where none of the conditions (i) to (iv) is satisfied, it is determined that the quality of the volume data is acceptable.
(i) The scan time exceeds a predetermined limit time tc.
(ii) The major axis deviation exceeds a predetermined error range γ.
(iii) The total change angle during the scan time exceeds a predetermined limit angle Ac.
(iv) The locus line density exceeds a predetermined limit density X [lines/deg].

Here, the limit time tc, the error range γ, the limit angle Ac, and the limit density X may be determined by the user who actually uses the ultrasound diagnostic apparatus 100, based on his or her experience.

In a case where any one of one or more conditions (selected conditions) selected in advance from among the conditions (i) to (iv) is satisfied, the controller 42 may determine that the quality of the volume data is unacceptable. In this case, in a case where none of the selected conditions is satisfied, the controller 42 may determine that the quality of the volume data is acceptable.

The conditions for determining the quality of the volume data (the conditions under which the quality is poor) may include, in addition to the conditions (i) to (iv), conditions in which the variation in angular interval of the locus line L, the strength of the positioning signal received by the position and orientation sensor 18, or the position of the ultrasound probe 12 in the scan time is used as the transport information.

That is, a condition (v) in which the variation in angular interval of the locus line L exceeds a limit variation may be included. Here, the variation in angular interval of the locus line L is defined as a variation in angle between the adjacent locus lines L, for the locus lines L displayed over the scan time. The variation may be a statistical value indicating a variation of a population, such as a variance or a standard deviation. In addition, the conditions for determining the quality of the volume data may include a condition (vi) in which a statistical value such as an average value, a minimum value, and a median value of the strength of the positioning signal received by the position and orientation sensor 18 over the scan time is less than a predetermined reception level lower limit value. Further, the conditions for determining the quality may include a condition (vii) in which the position of the ultrasound probe 12 in the scan time is outside a bounded three-dimensional space predetermined within a three-dimensional space. The bounded three-dimensional space may be set as, for example, a three-dimensional space in which the position and orientation sensor 18 receives a positioning signal with sufficient strength.

Even in this case, in a case where any one of one or more selected conditions selected in advance from among a plurality of conditions in which the quality is poor is satisfied, the controller 42 may determine that the quality of the volume data is unacceptable. In this case, in a case where none of the selected conditions is satisfied, the controller 42 may determine that the quality of the volume data is acceptable.

In a case where the linear scan is performed, the transport information indicating the transport status of the ultrasound probe 12 includes a scan time, a major axis deviation, a total movement distance during the scan time, a locus line density, and the like. Here, the total movement distance during the scan time is a distance by which the ultrasound probe 12 has moved during the scan time. The locus line density may be defined as a value obtained by dividing the number of locus lines L drawn within the scan time by the movement distance x.

In a case where the linear scan is performed, for example, in a case where at least one of the following conditions (a) to (d) is satisfied, the controller 42 determines that the quality of the volume data is unacceptable. On the other hand, in a case where none of the conditions (a) to (d) is satisfied, it is determined that the quality of the volume data is acceptable.
(a) The scan time exceeds a predetermined limit time Tc.
(b) The major axis deviation exceeds a predetermined error range Γ.
(c) The total movement distance during the scan time exceeds a predetermined limit distance Dc.
(d) The locus line density exceeds a predetermined limit density χ [lines/cm].

The limit time Tc, the error range Γ, the limit distance Dc, and the limit density χ may be determined by the user who actually uses the ultrasound diagnostic apparatus 100, based on his or her experience.

In a case where one selected condition selected in advance from among the conditions (a) to (d) is satisfied, or any one of a plurality of selected conditions selected in advance from among the conditions (a) to (d) is satisfied, the controller 42 may determine that the quality of the volume data is unacceptable. In this case, in a case where none of the selected conditions is satisfied, the controller 42 may determine that the quality of the volume data is acceptable.

The conditions for determining the quality of the volume data (the conditions under which the quality is poor) may include, in addition to the conditions (a) to (d), conditions in which the variation in distance interval of the locus line L, the strength of the positioning signal received by the position and orientation sensor 18, or the position of the ultrasound probe 12 over the scan time is used as the transport information.

That is, a condition (e) in which the variation in distance interval of the locus line L exceeds a limit variation may be included. Here, the variation in distance interval of the locus line L is defined as a variation in distance between the adjacent locus lines L, for the locus lines L displayed over the scan time. In addition, the conditions for determining the quality of the volume data may include a condition (f) in which a statistical value such as an average value, a minimum value, and a median value of the strength of the positioning signal received by the position and orientation sensor 18 over the scan time is less than a predetermined reception level lower limit value. Further, the conditions for determining the quality may include a condition (g) in which the position of the ultrasound probe 12 in the scan time is outside a bounded three-dimensional space predetermined within a three-dimensional space. The bounded three-dimensional space may be set as, for example, a three-dimensional space in which the position and orientation sensor 18 receives a positioning signal with sufficient strength.

Even in this case, in a case where any one of one or more selected conditions selected in advance from among a plurality of conditions in which the quality is poor is satisfied, the controller 42 may determine that the quality of the volume data is unacceptable. In this case, in a case where none of the selected conditions is satisfied, the controller 42 may determine that the quality of the volume data is acceptable.

The controller 42 may cause the display processing unit 26 to execute processing of displaying the quality of the volume data. The display processing unit 26 may display, on the display 46, information indicating whether or not there is a problem in the quality of the volume data.

The controller 42 may cause the display processing unit 26 to execute processing of displaying an image prompting the user to perform the scan with the ultrasound probe 12 again, together with the conditions under which the quality is poor, such as the conditions (i) to (vii) and the conditions (a) to (g). In addition, the controller 42 may cause the display processing unit 26 to execute processing of displaying an icon or a button for performing the scan with the ultrasound probe 12 again on the display 46. In this case, in response to the operation of the operation unit 44 on the icon or the button, the controller 42 may execute the processing of acquiring the volume data again as the processing of reacquiring the volume data.

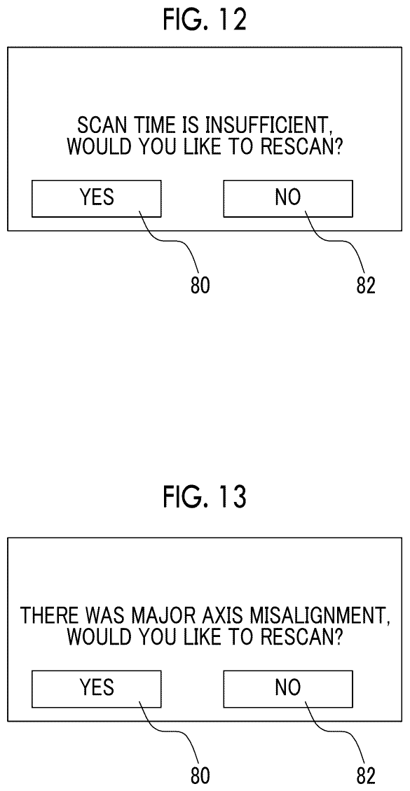

FIG. 12 shows an example of an image displayed on the display 46 in a case where the scan time exceeds limit time tc or Tc. In the example of FIG. 12, a message of “scan time is insufficient, would you like to rescan? ” is shown, and a button 80 labeled “yes” in a case where rescanning is desired and a button 82 labeled “no” in a case where rescanning is not desired are shown. In a case where the display 46 is a touch panel, the buttons 80 and 82 are operated by the user touching the touch panel with his or her finger. In addition, in a case where the display 46 is a liquid crystal panel or an organic EL panel, the buttons 80 and 82 are operated by cursor control via the operation unit 44.

FIG. 13 shows an example of an image displayed on the display 46 in a case where the major axis deviation is recognized. In the example of FIG. 13, a message of “there was major axis misalignment, would you like to rescan?” is shown, and a button 80 labeled “yes” in a case where rescanning is desired and a button 82 labeled “no” in a case where rescanning is not desired are shown.

In both FIGS. 12 and 13, pressing the button 80 labeled “yes” causes the controller 42 to wait for an operation to start the scan, whereas pressing the button 82 labeled “no” causes the controller 42 to end the operation mode for acquiring the volume data.

The display of the volume data stored in the volume data generation unit 30 or the storage unit 40 will be described. The image combining unit 24 may execute volume rendering on the volume data. The volume rendering is processing of, in a case where each voxel constituting the volume data is viewed from a certain direction in a three-dimensional space, projecting a pixel onto a drawing plane perpendicular to the line of sight. The pixel value of the pixel on the drawing plane has, for example, a value obtained by adding up the voxel values of the respective voxels on the line of sight. The image combining unit 24 generates volume rendering data indicating an image drawn on the drawing plane. The image combining unit 24 outputs the volume rendering data to the display processing unit 26, and the display processing unit 26 displays the volume rendering image on the display 46.

In addition, processing of cutting out and displaying the two-dimensional image on the drawing plane designated based on the operation of the user may be executed for the volume data. Specifically, the image combining unit 24 generates two-dimensional image data in which the voxel value of the voxel on the drawing plane is set as the pixel value. The image combining unit 24 outputs the two-dimensional image data to the display processing unit 26, and the display processing unit 26 displays the two-dimensional image on the display 46.

In general, volume data display processing such as volume rendering or two-dimensional image cutout processing for the volume data involves a large amount of information processing and takes a relatively long time. The ultrasound diagnostic apparatus 100 according to the present embodiment has a function of evaluating the quality of the volume data. Therefore, before executing the volume data display processing, processing of evaluating the quality of the volume data may be executed, and in a case where there is no problem in the evaluation result, the volume data display processing may be executed. This makes it possible to avoid performing unnecessary information processing, such as performing the volume data display processing on volume data of poor quality.

What is claimed is:

1. An ultrasound image processing apparatus comprising:
a position and orientation sensor provided in an ultrasound probe; and
a processor,
wherein the processor executes
processing of sequentially generating ultrasound image data over time based on ultrasound waves transmitted and received by the ultrasound probe,
processing of sequentially generating position and orientation information indicating a position and an orientation of the ultrasound probe over time based on detection signals output sequentially over time by the position and orientation sensor, and
processing of sequentially displaying, on a display unit, position and orientation figures indicating the position and the orientation of the ultrasound probe over time based on the position and orientation information generated sequentially over time.

2. The ultrasound image processing apparatus according to claim 1,
wherein the position and orientation figure has a shape extending in a certain direction,
the direction in which the position and orientation figure extends indicates the orientation of the ultrasound probe, and
a position of the position and orientation figure indicates the position of the ultrasound probe.

3. The ultrasound image processing apparatus according to claim 1,
wherein the processor executes
processing of obtaining future position and orientation information by performing estimation processing on the position and orientation information generated over time, and
processing of displaying an estimated range based on the future position and orientation information on the display unit.

4. An ultrasound image processing apparatus comprising:
a position and orientation sensor provided in an ultrasound probe; and
a processor,
wherein the processor executes
processing of sequentially generating ultrasound image data over time based on ultrasound waves transmitted and received by the ultrasound probe,
processing of obtaining a scan rate indicating the number of frames of the ultrasound image data acquired per predetermined amount of movement of the ultrasound probe based on a detection signal output by the position and orientation sensor, and
processing of displaying evaluation information for the scan rate on a display unit.

5. The ultrasound image processing apparatus according to claim 1,
wherein the position and orientation sensor receives a positioning signal transmitted from a positioning signal generation source, and outputs the detection signal based on the positioning signal, and
the processor causes the display unit to display information indicating strength of the positioning signal received by the position and orientation sensor.

6. The ultrasound image processing apparatus according to claim 4,
wherein the position and orientation sensor receives a positioning signal transmitted from a positioning signal generation source, and outputs the detection signal based on the positioning signal, and
the processor causes the display unit to display information indicating strength of the positioning signal received by the position and orientation sensor.

7. An ultrasound image processing apparatus comprising:
a position and orientation sensor fixed to an ultrasound probe; and
a processor,
wherein the processor executes
processing of sequentially generating ultrasound image data over time based on ultrasound waves transmitted and received by the ultrasound probe,
processing of generating transport information indicating a transport status of the ultrasound probe for volume data composed of the ultrasound image data of a predetermined number of frames, based on a detection signal output by the position and orientation sensor, and
processing of determining quality of the volume data based on the transport information.
